(19) United States
(12) Patent Application Publication
(10) Pub. No.: US 2024/0214139 A1
(43) Pub. Date: Jun. 27, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/539,305

(22) Filed: Dec. 14, 2023

(30) Foreign Application Priority Data
Dec. 23, 2022 (CN) 202211664710.5

(51) Int. Cl. H04L 5/00; H04L 1/00; H04W 72/20

(52) U.S. Cl. CPC H04L 5/0044; H04L 1/0013; H04W 72/20

(57) ABSTRACT

A first receiver receives a first signaling; and a first transmitter transmits a first information block and at least one TB on a first channel; herein, the first signaling is used for scheduling the first channel, and a first number is used for transmission of the first information block on the first channel, the first number being related to a number of TB(s) transmitted on the first channel and equal to a smallest one of multiple values; one of the multiple values depends on a result obtained by rounding up a product of a first parameter and a first resource size to a nearest integer, where the first parameter is configurable, and the first resource size is linear with at least one sub resource size, of which each sub resource size is a number of RE(s) allowed to be used for transmitting UCI in an OFDM symbol.

### CROSS REFERENCE TO RELATED APPLICATIONS

This application claims the priority benefit of Chinese Patent Application No. 202211664710.5, filed on Dec. 23, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In discussions about 5G New Radio (NR), the 3GPP has agreed upon the provision of support for transmitting two codewords on a Physical uplink shared channel (PUSCH). After introducing the function of transmitting two codewords with one PUSCH, how to achieve the multiplexing of Uplink control information (UCI) on the PUSCH is a key issue that must be addressed.

### SUMMARY

To address the above problem, the present application provides a solution. It should be noted that apart from the PUSCH described above, this application is also applicable to other uplink physical layer channels, e.g., a PUCCH. The present application is applicable to a variety of wireless communication scenarios, such as Enhance Mobile Broadband (eMBB), Ultra Reliable and Low Latency Communication (URLLC), Multicast Broadcast Services (MBS), Internet of Things (IoT), V2X, non-terrestrial networks (NTN), and shared spectrum, where similar technical effects can be achieved. Additionally, the adoption of a unified solution for various scenarios, including but not limited to eMBB, URLLC, MBS, IoT, V2X, NTN and shared spectrum, contributes to the reduction of hardcore complexity and costs, or the enhancement of performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling; and
transmitting a first information block and at least one transport block (TB) on a first channel;
herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one embodiment, an advantage of the above method includes: enhancing the transmission performance of UCI on the first channel.

In one embodiment, an advantage of the above method includes: enhancing the performance of HARQ-ACK feedback.

In one embodiment, an advantage of the above method includes: enhancing the performance of CSI reporting.

In one embodiment, an advantage of the above method includes: optimizing the resource allocation between multiplexed UCI and Uplink shared channel (UL-SCH) transport blocks.

In one embodiment, an advantage of the above method includes: enhancing the transmission performance of TBs on the first channel.

In one embodiment, an advantage of the above method includes: increasing the resource utilization ratio.

In one embodiment, an advantage of the above method includes: being easily compatible.

In one embodiment, an advantage of the above method includes: allowing for small amendment to the existing 3GPP specifications.

According to one aspect of the present application, the above method is characterized in that,
when the number of TB(s) transmitted on the first channel is greater than 1, the first number is associated with a reference TB, the reference TB being one of the at least one TB.

According to one aspect of the present application, the above method is characterized in that,
a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

According to one aspect of the present application, the above method is characterized in that,
a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

According to one aspect of the present application, the above method is characterized in that,
the first signaling is a DCI, and the first channel is a PUSCH, and the first information block is a CSI part 1.

According to one aspect of the present application, the above method is characterized in that,
the first signaling is a first DCI, and the first channel is a first PUSCH, and the first information block is a CSI part 1; a first reference value is one of the multiple values; whether the first reference value is less than a result obtained by rounding up the product of the first parameter and the first resource size to a nearest integer is related to a number of TB(s) transmitted on the first PUSCH, and the first resource size is a sum of multiple sub resource sizes, each of the multiple sub resource sizes being a number of RE(s) allowed to be used for transmitting UCI in an OFDM symbol.

According to one aspect of the present application, the above method is characterized in comprising:
receiving a second parameter, the second parameter indicating a maximum number of TB(s) or codeword(s) on a PUSCH;
herein, whether the first reference value is less than the result obtained by rounding up the product of the first parameter and the first resource size to a nearest integer is related to the second parameter.

According to one aspect of the present application, the above method is characterized in that,
when the second parameter indicates that a maximum number of TB(s) or codeword(s) on a PUSCH is 1, the first PUSCH is used for transmitting at most one TB, and the first reference value is less than the result obtained by rounding up the product of the first parameter and the first resource size to a nearest integer; when the number of TBs transmitted on the first PUSCH is equal to 2, the first reference value is the result obtained by rounding up the product of the first parameter and the first resource size to a nearest integer.

The present application provides a method in a second node for wireless communications, comprising:
transmitting a first signaling; and
receiving a first information block and at least one TB on a first channel;
herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

According to one aspect of the present application, the above method is characterized in that,
when the number of TB(s) transmitted on the first channel is greater than 1, the first number is associated with a reference TB, the reference TB being one of the at least one TB.

According to one aspect of the present application, the above method is characterized in that,
a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

According to one aspect of the present application, the above method is characterized in that,
a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

According to one aspect of the present application, the above method is characterized in that,
the first signaling is a DCI, and the first channel is a PUSCH, and the first information block is a CSI part 1.

According to one aspect of the present application, the above method is characterized in that,
the first signaling is a first DCI, and the first channel is a first PUSCH, and the first information block is a CSI part 1; a first reference value is one of the multiple values; whether the first reference value is less than a result obtained by rounding up the product of the first parameter and the first resource size to a nearest integer is related to a number of TB(s) transmitted on the first PUSCH, and the first resource size is a sum of multiple sub resource sizes, each of the multiple sub resource sizes being a number of RE(s) allowed to be used for transmitting UCI in an OFDM symbol.

According to one aspect of the present application, the above method is characterized in comprising:
transmitting a second parameter, the second parameter indicating a maximum number of TB(s) or codeword(s) on a PUSCH;
herein, whether the first reference value is less than the result obtained by rounding up the product of the first parameter and the first resource size to a nearest integer is related to the second parameter.

According to one aspect of the present application, the above method is characterized in that,
when the second parameter indicates that a maximum number of TB(s) or codeword(s) on a PUSCH is 1, the first PUSCH is used for transmitting at most one TB, and the first reference value is less than the result obtained by rounding up the product of the first parameter and the first resource size to a nearest integer; when the number of TBs transmitted on the first PUSCH is equal to 2, the first reference value is the result obtained by rounding up the product of the first parameter and the first resource size to a nearest integer.

The present application provides a first node for wireless communications, comprising:
a first receiver, receiving a first signaling; and
a first transmitter, transmitting a first information block and at least one transport block (TB) on a first channel;
herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

The present application provides a second node for wireless communications, comprising:
a second transmitter, transmitting a first signaling; and
a second receiver, receiving a first information block and at least one TB on a first channel;
herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram of relations among a first number, a reference TB and at least one TB according to one embodiment of the present application.

FIG. 7 illustrates a schematic diagram explaining a first parameter according to one embodiment of the present application.

FIG. 8 illustrates a schematic diagram explaining a first reference value according to one embodiment of the present application.

FIG. 9 illustrates a schematic diagram explaining a first reference value according to one embodiment of the present application.

FIG. 10 illustrates a structure block diagram of a processing device in a first node according to one embodiment of the present application.

FIG. 11 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

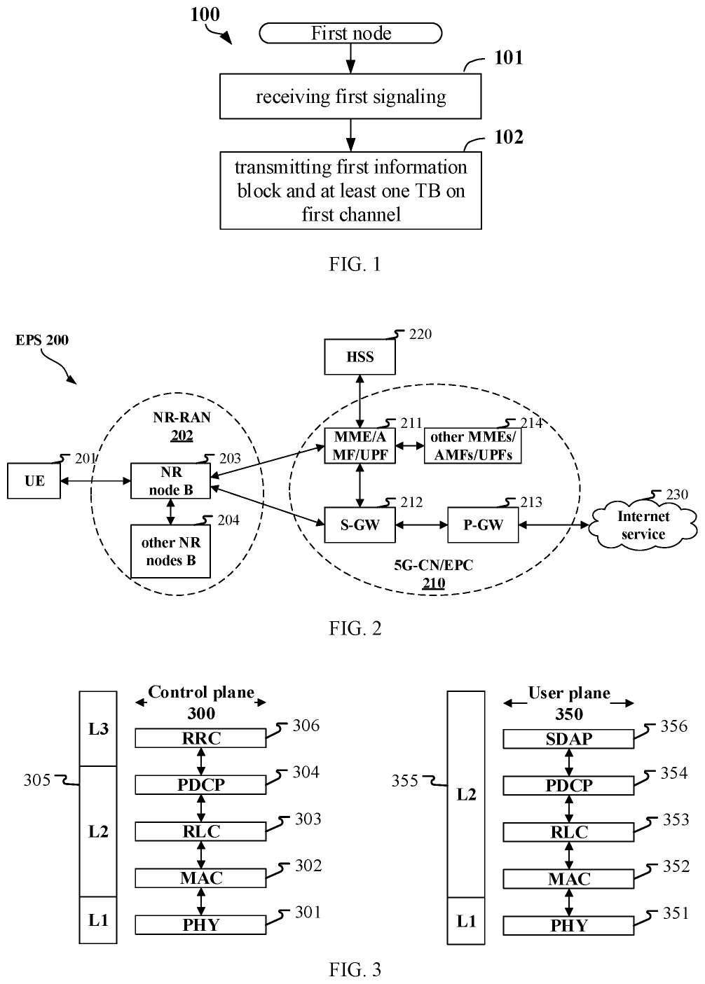

Embodiment 1 illustrates a flowchart of processing of a first node according to one embodiment of the present application, as shown in FIG. 1.

In Embodiment 1, the first node in the present application receives a first signaling instep 101; and transmits a first information block and at least one TB on a first channel in step 102.

In Embodiment 1, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one embodiment, the first signaling is an UpLink Grant Signaling.

In one embodiment, the first signaling is a piece of Downlink control information (DCI).

In one embodiment, the first signaling is a DCI format.

In one embodiment, the first signaling is DCI format 0_1.

In one embodiment, the first signaling is DCI format 0_2.

In one embodiment, the first signaling uses one of DCI format 00, DCI format 0_1 or DCI format 0_2.

In one embodiment, the first signaling uses a DCI format other than DCI format 00, DCI format 0_1 and DCI format 0_2.

In one embodiment, the first signaling is a DCI comprising UL grant.

In one embodiment, the first signaling comprises at least one field in a DCI format.

In one embodiment, the first signaling comprises a higher layer parameter.

In one embodiment, the first signaling comprises an RRC signaling.

In one embodiment, the first signaling is dynamically configured.

In one embodiment, the first signaling comprises a layer 1 (L1) signaling.

In one embodiment, the first signaling comprises one or more fields in a physical layer signaling.

In one embodiment, the first signaling comprises a Higher Layer signaling.

In one embodiment, the first signaling comprises one or more fields in a Higher Layer signaling.

In one embodiment, the first signaling comprises a Radio Resource Control (RRC) signaling.

In one embodiment, the first signaling comprises a Medium Access Control layer Control Element (MAC CE).

In one embodiment, the first signaling comprises one or more fields in an RRC signaling.

In one embodiment, the first signaling comprises one or more fields in a MAC CE.

In one embodiment, the first signaling comprises one or more fields in an Information Element (IE).

In one embodiment, the first signaling comprises Sidelink Control Information (SCI).

In one embodiment, the first signaling comprises one or more fields in an SCI.

In one embodiment, the first channel is a physical layer channel.

In one embodiment, the first channel is an uplink channel.

In one embodiment, the first channel is a Physical uplink shared channel (PUSCH).

In one embodiment, the first channel is a Physical sidelink shared channel (PSSCH).

In one embodiment, the first channel is a Physical uplink Control channel (PUCCH).

In one embodiment, the first information block comprises UCI.

In one embodiment, the first information block comprises Channel state information (CSI).

In one embodiment, the first information block comprises a CSI part 1.

In one embodiment, the first information block comprises Hybrid automatic repeat request acknowledgement (HARQ-ACK) information.

In one embodiment, the first information block comprises control information in a higher layer.

In one embodiment, a TB transmitted on the first channel is an Uplink shared channel (UL-SCH) transport block.

In one embodiment, a TB transmitted on the first channel comprises multiple bits.

In one embodiment, a TB transmitted on the first channel comprises at least one code block.

In one embodiment, coded bits of the first information block are multiplexed on the first channel.

In one embodiment, coded bits of the first information block and coded bits of at least one TB are transmitted on the first channel after being multiplexed.

In one embodiment, the first information block is transmitted on the first channel after being through at least part of CRC attachment, Code block segmentation, Code block CRC attachment, Channel coding, Rate matching, Code block concatenation, Scrambling, Modulation, Layer mapping, Transform precoding, Precoding, Mapping to virtual resource blocks, Mapping from virtual to physical resource blocks, Multicarrier symbol generation, and Modulation and Upconversion.

In one embodiment, at least one TB is transmitted on the first channel after being through at least part of CRC attachment, Code block segmentation, Code block CRC attachment, Channel coding, Rate matching, Code block concatenation, Scrambling, Modulation, Layer mapping, Transform precoding, Precoding, Mapping to virtual resource blocks, Mapping from virtual to physical resource blocks, Multicarrier symbol generation, and Modulation and Upconversion.

In one embodiment, coded bits of at least one TB are transmitted on the first channel after being through at least part of Scrambling, Modulation, Layer mapping, Antenna port mapping, Mapping to virtual resource blocks, Mapping from virtual to physical resource blocks, Multicarrier symbol generation, and Modulation and Upconversion.

In one embodiment, coded bits of the first information block are transmitted on the first channel after being through at least part of Scrambling, Modulation, Layer mapping, Antenna port mapping, Mapping to virtual resource blocks, Mapping from virtual to physical resource blocks, Multicarrier symbol generation, and Modulation and Upconversion.

In one embodiment, at least one TB is transmitted on the first channel after being through at least part of CRC attachment, Code block segmentation, Code block CRC attachment, Channel coding, Rate matching, Code block concatenation, Scrambling, Modulation, Layer mapping, Precoding, Antenna port mapping, Mapping to virtual resource blocks, Mapping from virtual to physical resource blocks, Multicarrier symbol generation, and Modulation and Upconversion.

In one embodiment, the first information block is transmitted on the first channel after being through at least part of CRC attachment, Code block segmentation, Code block CRC attachment, Channel coding, Rate matching, Code block concatenation, Scrambling, Modulation, Layer mapping, Precoding, Antenna port mapping, Mapping to virtual resource blocks, Mapping from virtual to physical resource blocks, Multicarrier symbol generation, and Modulation and Upconversion.

In one embodiment, a field in the first signaling indicates time-domain resources occupied by the first channel.

In one embodiment, a field in the first signaling indicates frequency-domain resources occupied by the first channel.

In one embodiment, a field in the first signaling indicates spatial-domain resources occupied by the first channel.

In one embodiment, resources occupied by transmission of the first information block on the first channel depend on the first number.

In one embodiment, a coded bit sequence of the first information block depends on the first number.

In one embodiment, a length of a coded bit sequence of the first information block depends on the first number.

In one embodiment, a rate matching output sequence length of a code block corresponding to the first information block depends on the first number.

In one embodiment, the statement that “a first number is used for transmission of the first information block on the first channel” means that: a first number is a number of coding and modulation symbols per layer for CSI part 1 transmission.

In one embodiment, the statement that “a first number is used for transmission of the first information block on the first channel” means that: a first number is a number of coding and modulation symbols per layer for CSI part 1 transmission for at least one transmission layer to which a TB is mapped.

In one embodiment, the statement that “a first number is used for transmission of the first information block on the first channel” means that: a coded bit sequence of the first information block is multiplexed onto the first channel, a first number being used to determine the coded bit sequence of the first information block.

In one embodiment, the statement that “a first number is used for transmission of the first information block on the first channel” means that: a rate matching output sequence length of a code block corresponding to the first information block depends on the first number.

In one embodiment, the statement that “a first number is used for transmission of the first information block on the first channel” means that: a rate matching output sequence length of a code block corresponding to the first information block is related to the first number.

In one embodiment, the first number is a number of coding and modulation symbols per layer for CSI part 1 transmission.

In one embodiment, the first number is a number of coding and modulation symbols per layer for CSI part 1 transmission for at least one transmission layer to which a TB is mapped.

In one embodiment, a coded bit sequence of the first information block is multiplexed onto the first channel, the first number being used to determine the coded bit sequence of the first information block.

In one embodiment, a coded bit sequence of the first information block is multiplexed onto the first channel, the first number implicitly indicating the coded bit sequence of the first information block.

In one embodiment, a rate matching output sequence length of a code block corresponding to the first information block depends on the first number.

In one embodiment, a rate matching output sequence length of a code block r corresponding to the first information block=└E/C┘, with E equal to a product of multiple factors, the first number being one of the multiple factors; where r is a code block number, and C is a number of code block(s) corresponding to the first information block.

In one embodiment, a rate matching output sequence length of a code block r corresponding to the first information block=└E/C┘, with E equal to a sum of multiple addends, one of the multiple addends being equal to a product of multiple factors, the first number being one of the multiple factors; where r is a code block number, and C is a number of code block(s) corresponding to the first information block.

In one embodiment, when the number of TB(s) transmitted on the first channel is equal to 1: a rate matching output sequence length of a code block r corresponding to the first information block=└E/C┘, with E equal to a product of multiple factors, the first number being one of the multiple factors; where r is a code block number, and C is a number of code block(s) corresponding to the first information block.

In one embodiment, when the number of TB(s) transmitted on the first channel is greater than 1: a rate matching output sequence length of a code block r corresponding to the first information block=└E/C┘, with E equal to a sum of multiple addends, one of the multiple addends being equal to a product of multiple factors, the first number being one of the multiple factors; where r is a code block number, and C is a number of code block(s) corresponding to the first information block.

In one embodiment, each of the multiple addends is respectively for a TB of the at least one TB.

In one embodiment, the multiple factors are all integers.

In one embodiment, the multiple factors are all positive numbers.

In one embodiment, one of the multiple factors is a number of transmission layer(s).

In one embodiment, one of the multiple factors is a modulation order.

In one embodiment, one of the multiple factors is a number of transmission layer(s) occupied by one of the at least one TB.

In one embodiment, one of the multiple factors is a modulation order of one of the at least one TB.

In one embodiment, one of the multiple factors is a sum of a modulation order of one of the at least one TB and a modulation order of another one of the at least one TB.

In one embodiment, one of the multiple factors is equal to a sum of a modulation order of one of the at least one TB and a modulation order of another one of the at least one TB being divided by 2.

In one embodiment, when the number of TB(s) transmitted on the first channel is greater than 1: one of the multiple factors is a number of transmission layer(s) occupied by a reference TB, the reference TB being one of the at least one TB.

In one embodiment, when the number of TB(s) transmitted on the first channel is greater than 1: one of the multiple factors is a modulation order of a reference TB, the reference TB being one of the at least one TB.

In one embodiment, when the number of TB(s) transmitted on the first channel is equal to 1: one of the multiple factors is a number of transmission layer(s) occupied by an enabled TB.

In one embodiment, when the number of TB(s) transmitted on the first channel is equal to 1: one of the multiple factors is a modulation order of an enabled TB.

In one embodiment, for a serving cell where the first channel is present, a maximum number of TBs transmitted on a PUSCH is equal to 2.

In one embodiment, for a serving cell where the first channel is present, a maximum number of codewords scheduled by a DCI is equal to 2.

In one embodiment, any addend of the multiple addends is equal to a product of multiple factors, and the first number is one of the multiple factors corresponding to the any addend of the multiple addends.

In one embodiment, a rate matching output sequence length of a code block r corresponding to the first information block=└E/C┘, where E=N×the first number×Q; where r is a code block number, C is a number of code block(s) corresponding to the first information block, N is a number of transmission layer(s), and Q is a modulation order.

In one embodiment, the number of coding and modulation symbols per layer for CSI part 1 transmission is for a TB transmitted on the first PUSCH.

In one embodiment, the statement “the first number being related to a number of TB(s) transmitted on the first channel” comprises that: the number of TB(s) transmitted on the first channel is 1, and the first node does not expect UCI and 2 TBs to be multiplexed onto a same PUSCH.

In one embodiment, the statement “the first number being related to a number of TB(s) transmitted on the first channel” comprises that: the number of TB(s) transmitted on the first channel is 1, and the first node expects UCI and at most one TB to be multiplexed onto a same PUSCH.

In one embodiment, the statement “the first number being related to a number of TB(s) transmitted on the first channel” comprises that: when the number of TB(s) transmitted on the first channel is greater than 1, the first number is associated with a reference TB, the reference TB being one of the at least one TB.

In one embodiment, the meaning of the statement “the first number being related to a number of TB(s) transmitted on the first channel” is that: the number of TB(s) transmitted on the first channel is 1, and the first node does not expect UCI and 2 TBs to be multiplexed onto a same PUSCH.

In one embodiment, the meaning of the statement “the first number being related to a number of TB(s) transmitted on the first channel” is that: the number of TB(s) transmitted on the first channel is 1, and the first node expects UCI and at most one TB to be multiplexed onto a same PUSCH.

In one embodiment, the meaning of the statement “the first number being related to a number of TB(s) transmitted on the first channel” is that: when the number of TB(s) transmitted on the first channel is greater than 1, the first number is associated with a reference TB, the reference TB being one of the at least one TB.

In one embodiment, when a number of TB(s) transmitted on the first channel is greater than 1, one of the multiple values is

$$⌈ \frac{( O + L ) \cdot β \cdot {\sum }_{l = 0}^{N} M ( l )}{{\sum }_{r = 0}^{{C}_{TB} - 1} {K}_{r}} ⌉ ;$$

where O is equal to a number of bits in the first information block, L is equal to a number of Cyclic redundancy check (CRC) bit(s) for the first information block, β is an offset value for the first information block, M(l) is a number of resource element(s) (RE(s)) in OFDM symbol l that can be used for transmitting UCI, N is a total number of OFDM symbols of the first channel, a is configured by a higher layer parameter scaling, Kᵣ is a size of a r-th code block in a TB transmitted on the first channel, and C_{TB} is a number of code blocks in the TB transmitted on the first channel.

In one embodiment, when a number of TB(s) transmitted on the first channel is equal to 2, one of the multiple values is

$$⌈ \frac{( O + L ) \cdot β \cdot {\sum }_{l = 0}^{N} M ( l )}{{\sum }_{r 1 = 0}^{{C}_{TB 1} - 1} {K}_{r 1} + {\sum }_{r 2 = 0}^{{C}_{TB 2} - 1} {K}_{r 2}} ⌉ ;$$

where O is equal to a number of bits in the first information block, L is equal to a number of CRC bit(s) for the first information block, β is an offset value for the first information block, M(l) is a number of RE(s) in OFDM symbol l that can be used for transmitting UCI, N is a total number of OFDM symbols of the first channel, a is configured by a higher layer parameter scaling, and Kᵣ₁ is a size of a r1-th code block in a TB transmitted on the first channel, the C_{TB1} is a number of code blocks in the TB transmitted on the first channel, while Kᵣ₂ is a size of a r2-th code block in another TB transmitted on the first channel, the C_{TB2} is a number of code blocks in the other TB transmitted on the first channel.

In one embodiment, when a number of TB(s) transmitted on the first channel is equal to 2, one of the multiple values is

$$⌈ \frac{2 ( O + L ) \cdot β \cdot {\sum }_{l = 0}^{N} M ( l )}{{\sum }_{r 1 = 0}^{{C}_{TB 1} - 1} {K}_{r 1} + {\sum }_{r 2 = 0}^{{C}_{TB 2} - 1} {K}_{r 2}} ⌉ ;$$

where O is equal to a number of bits in the first information block, L is equal to a number of CRC bit(s) for the first information block, β is an offset value for the first information block, M(l) is a number of RE(s) in OFDM symbol l that can be used for transmitting UCI, N is a total number of OFDM symbols of the first channel, a is configured by a higher layer parameter scaling, and Kᵣ₁ is a size of a r1-th code block in a TB transmitted on the first channel, the C_{TB1} is a number of code blocks in the TB transmitted on the first channel, while Kᵣ₂ is a size of a r2-th code block in another TB transmitted on the first channel, the C_{TB2} is a number of code blocks in the other TB transmitted on the first channel.

In one embodiment, when the number of TB(s) transmitted on the first channel is equal to 1, the first number is associated with the TB transmitted on the first channel.

In one embodiment, when a number of TB(s) transmitted on the first channel is equal to 1, one of the multiple values is

$$⌈ \frac{( O + L ) \cdot β \cdot {\sum }_{l = 0}^{N} M ( l )}{{\sum }_{r 1 = 0}^{{C}_{TB 1} - 1} {K}_{r 1}} ⌉ ;$$

where O is equal to a number of bits in the first information block, L is equal to a number of CRC bit(s) for the first information block, β is an offset value for the first information block, M(l) is a number of RE(s) in OFDM symbol l that can be used for transmitting UCI, N is a total number of OFDM symbols of the first channel, a is configured by a higher layer parameter scaling, Kᵣ₁ is a size of a r1-th code block in the TB transmitted on the first channel, and C_{TB1} is a number of code blocks in the TB transmitted on the first channel.

In one embodiment, the first number is equal to a smallest one of multiple values, a first reference value being one of the multiple values; when the number of TB(s) transmitted on the first channel is greater than 1, the first reference value is equal to a result obtained by rounding up a product of a first parameter and a first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, the first number is equal to a smallest one of multiple values, a first reference value being one of the multiple values; when the number of TB(s) transmitted on the first channel is equal to 1, the first reference value is less than a result obtained by rounding up a product of a first parameter and a first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, the multiple values are 2 values.

In one embodiment, the multiple values are 3 values.

In one embodiment, the multiple values are 4 values.

In one embodiment, the multiple values are 5 values.

In one embodiment, the first signaling is a first DCI, and the first channel is a first PUSCH, and the first information block is a CSI part 1; the statement in the present application that “the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol” and the statement that “the first DCI is used for scheduling the first PUSCH; a first number is used for transmission of a CSI part 1 on the first PUSCH, the first number being equal to a smallest one of multiple values, and a first reference value is one of the multiple values; whether the first reference value is less than a result obtained by rounding up a product of a first parameter and a first resource size to a nearest integer is related to a number of TB(s) transmitted on the first PUSCH, where the first parameter is configurable, and the first resource size is a sum of multiple sub resource sizes, each of the multiple sub resource sizes being a number of RE(s) allowed to be used for transmitting UCI in an OFDM symbol” have equivalent meaning or are mutually replaceable.

In one embodiment, the statement in the present application that “one of the multiple values depends on a result obtained by rounding up a product of a first parameter and a first resource size to a nearest integer” and the statement that “one of the multiple values is no greater than a result obtained by rounding up a product of a first parameter and a first resource size to a nearest integer” have equivalent meaning or are mutually replaceable.

In one embodiment, the statement in the present application that “one of the multiple values depends on a result obtained by rounding up a product of a first parameter and a first resource size to a nearest integer” and the statement that “one of the multiple values is related to a result obtained by rounding up a product of a first parameter and a first resource size to a nearest integer, and no greater than the result obtained by rounding up the product of the first parameter and the first resource size to a nearest integer” have equivalent meaning or are mutually replaceable.

In one embodiment, a result obtained by rounding up a product of the first parameter and the first resource size to a nearest integer is: [the first parameter×the first resource size].

In one embodiment, a result obtained by rounding up a product of the first parameter and the first resource size to a nearest integer is a smallest integer no less than the product of the first parameter and the first resource size.

In one embodiment, the statement in the present application that “the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol” means that: the first resource size is a number of RE(s) allowed to be used for transmitting UCI in an OFDM symbol, or, the first resource size is a sum of multiple sub resource sizes, each of the multiple sub resource sizes being a number of RE(s) allowed to be used for transmitting UCI in an OFDM symbol.

In one embodiment, the statement in the present application that “the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol” means that: the first resource size is a sum of multiple sub resource sizes, each of the multiple sub resource sizes being a number of RE(s) allowed to be used for transmitting UCI in an OFDM symbol.

In one embodiment, the first resource size is a number of REs allowed to be used for transmitting UCI in an OFDM symbol.

In one embodiment, the first resource size is a sum of multiple sub resource sizes, each of the multiple sub resource sizes being a number of RE(s) allowed to be used for transmitting UCI in an OFDM symbol.

In one embodiment, a number of REs allowed to be used for transmitting UCI in an OFDM symbol is: a number of resource elements that can be used for transmission of UCI in an Orthogonal frequency division multiplex (OFDM) symbol.

In one embodiment, the number of TB(s) transmitted on the first channel is no greater than 2.

In one embodiment, a first reference value is one of the multiple values; when the number of TB(s) transmitted on the first channel is greater than 1, the first reference value is less than a result obtained by rounding up a product of the first parameter and the first resource size to a nearest integer; when the number of TB(s) transmitted on the first channel is equal to 1, the first reference value is no less than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, a first reference value is one of the multiple values; when the number of TB(s) transmitted on the first channel is greater than 1, the first reference value is no less than a result obtained by rounding up a product of the first parameter and the first resource size to a nearest integer; when the number of TB(s) transmitted on the first channel is equal to 1, the first reference value is less than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, a first reference value is one of the multiple values; when the number of TB(s) transmitted on the first channel is greater than 1, the first reference value is greater than a result obtained by rounding up a product of the first parameter and the first resource size to a nearest integer; when the number of TB(s) transmitted on the first channel is equal to 1, the first reference value is no greater than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, a first reference value is one of the multiple values; when the number of TB(s) transmitted on the first channel is greater than 1, the first reference value is no greater than a result obtained by rounding up a product of the first parameter and the first resource size to a nearest integer; when the number of TB(s) transmitted on the first channel is equal to 1, the first reference value is greater than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, the meaning of the statement “the first number being related to a number of TB(s) transmitted on the first channel” is that:
a second parameter is used for indicating a maximum number of TB(s) or codeword(s) on a PUSCH; when the number of TB(s) transmitted on the first channel is greater than 1, the first reference value is equal to a result obtained by rounding up a product of the first parameter and the first resource size to a nearest integer; when the second parameter indicates that a maximum number of TB(s) or codeword(s) on a PUSCH is 1, the first reference value is less than the result obtained by rounding up the product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, the meaning of the statement “the first number being related to a number of TB(s) transmitted on the first channel” is that:
the second parameter is used for indicating a maximum number of TB(s) or codeword(s) scheduled by a DCI; when the number of TB(s) transmitted on the first channel is greater than 1, the first reference value is equal to a result obtained by rounding up a product of the first parameter and the first resource size to a nearest integer; when the second parameter indicates that a maximum number of TB(s) or codeword(s) scheduled by a DCI is 1, the first reference value is less than the result obtained by rounding up the product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called abase station, abase transceiver station, a radio base station, a radio transceiver, a transceiver function, a Base Service Set (BSS), anExtended Service Set (ESS), a Transmitter Receiver Point (TRP) or some other applicable terms. The gNB 203 provides an access point of the EPC/5G-CN 210 for the UE 201. Examples of UE 201 include cellular phones, smartphones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises aMobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the UE 201 is a UE.

In one embodiment, the UE 201 is a UE supporting multicast transmission.

In one embodiment, the UE 201 is a normal UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MacroCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station supporting large time-delay difference.

In one embodiment, the gNB 203 is a flight platform.

In one embodiment, the gNB 203 is satellite equipment.

In one embodiment, the gNB 203 is a base station with network energy saving enhancement on.

In one embodiment, the first node and the second node in the present application both correspond to the UE 201, for instance, V2X communications is performed between the first node and the second node.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the PHY 301.

In one embodiment, the first channel in the present application is generated by the PHY 301.

In one embodiment, the first channel in the present application is generated by the PHY 351.

In one embodiment, the first information block in the present application is generated by the RRC sublayer 306.

In one embodiment, the first information block in the present application is generated by the MAC sublayer 302.

In one embodiment, the first information block in the present application is generated by the PHY 301.

### Embodiment 4

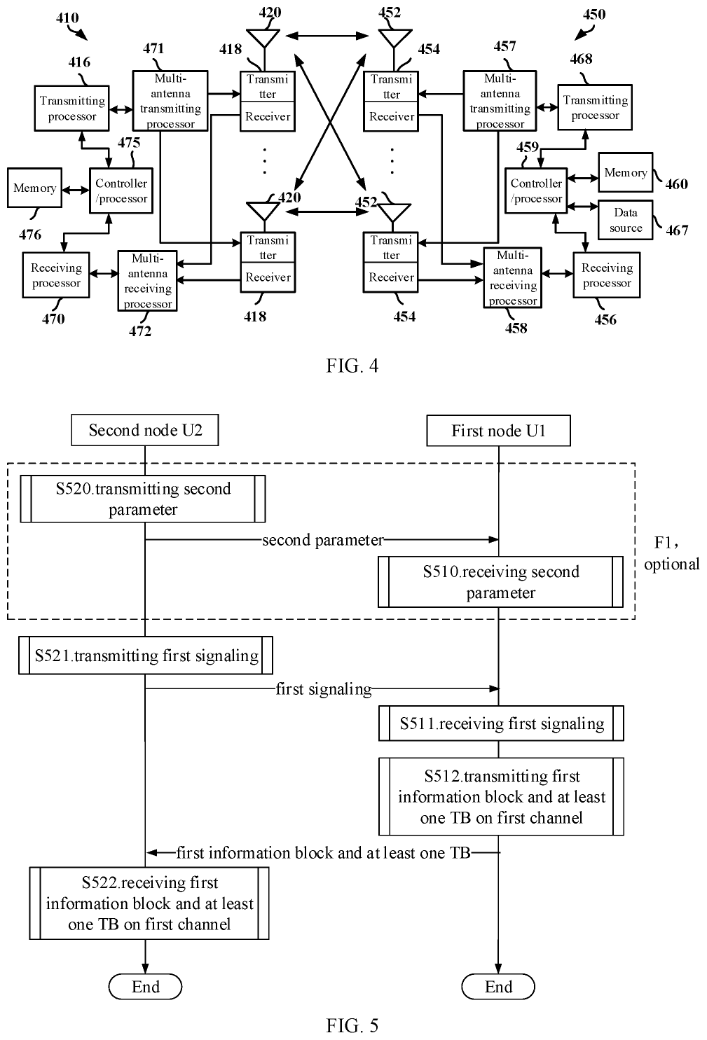

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a first signaling; and transmits a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one subembodiment, the second communication device 450 corresponds to the first node in the present application.

In one embodiment, the second communication device 450 comprises a memory that stores a computer readable instruction program, the computer readable instruction program generates actions when executed by at least one processor, which include: receiving a first signaling; and transmitting a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one subembodiment, the second communication device 450 corresponds to the first node in the present application.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a first signaling; and receives a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one subembodiment, the first communication device 410 corresponds to the second node in the present application.

In one embodiment, the first communication device 410 comprises a memory that stores a computer readable instruction program, the computer readable instruction program generates actions when executed by at least one processor, which include: transmitting a first signaling; and receiving a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the receiver 454, the multi-antenna receiving processor 458, the receiving processor 456, the controller/processor 459, the memory 460, or the data source 467 is used for receiving the second parameter in the present application.

In one embodiment, at least one of the antenna 420, the transmitter 418, the multi-antenna transmitting processor 471, the transmitting processor 416, the controller/processor 475 or the memory 476 is used for transmitting the second parameter in the present application.

In one embodiment, at least one of the antenna 452, the transmitter 454, the multi-antenna transmitting processor 458, the transmitting processor 468, the controller/processor 459, the memory 460 or the data source 467 is used for performing a transmission on the first channel in the present application.

In one embodiment, at least one of the antenna 420, the receiver 418, the multi-antenna receiving processor 472, the receiving processor 470, the controller/processor 475, or the memory 476 is used for performing a reception on the first channel in the present application.

### Embodiment 5

Embodiment 5 illustrates a flowchart of signal transmission according to one embodiment of the present application, as shown in FIG. 5. In FIG. 5, a first node U1 and a second node U2 are in communications via an air interface. Specially, steps marked by the dotted-line box F1 are optional.

The first node U1 receives a second parameter in step S510; and receives a first signaling in step S511; and transmits a first information block and at least one TB on a first channel in step S512.

The second node U2 transmits a second parameter in step S520; transmits a first signaling in step S521; and receives a first information block and at least one TB on a first channel in step S522.

In Embodiment 5, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer; a first reference value is one of the multiple values; when the number of TB(s) transmitted on the first channel is greater than 1, the first reference value is equal to a result obtained by rounding up a product of the first parameter and the first resource size to a nearest integer; when the number of TB(s) transmitted on the first channel is equal to 1, the first reference value is less than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol; the first signaling is a DCI, and the first channel is a PUSCH, and the first information block is a CSI part 1.

In one subembodiment of Embodiment 5, the second parameter is used for indicating a maximum number of TB(s) or codeword(s) on a PUSCH; when the second parameter indicates that a maximum number of TB(s) or codeword(s) on a PUSCH is 1, the first reference value is less than the result obtained by rounding up the product of the first parameter and the first resource size to a nearest integer.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a satellite device and a UE.

In one embodiment, an air interface between the second node U2 and the first node U1 includes a radio interface between a UE and another UE.

In one embodiment, a problem to be solved in the present application includes: how to determine the first number.

In one embodiment, a problem to be solved in the present application includes: how to determine the first reference value.

In one embodiment, a problem to be solved in the present application includes: how to optimize the resource allocation between UCI and TBs.

In one embodiment, a problem to be solved in the present application includes: how to increase the resource utilization ratio of a PUSCH.

In one embodiment, a problem to be solved in the present application includes: how to increase the resource utilization ratio of a PSSCH.

In one embodiment, a problem to be solved in the present application includes: how to enhance the performance of UCI feedback.

In one embodiment, a problem to be solved in the present application includes: how to enhance the transmission performance of a UL-SCH.

In one embodiment, a problem to be solved in the present application includes: how to enhance the transmission performance of a UCI or UL-SCH by making use of spatial-domain Diversity gain.

In one embodiment, a problem to be solved in the present application includes: how to enhance the transmission performance of a PUSCH multiplexed with UCI in a Multiple Transmit/Receive Point (multi-TRP) scenario.

In one embodiment, a problem to be solved in the present application includes: how to enhance the transmission performance of a PUSCH multiplexed with UCI in a Single Transmit/Receive Point (s-TRP) scenario.

In one embodiment, a problem to be solved in the present application includes: how to enhance the transmission performance of a PUSCH multiplexed with UCI in a Multiple Input Multiple Output (MIMO) scenario.

In one embodiment, steps marked by the dotted-line box F1 exist.

In one embodiment, steps marked by the dotted-line box F1 do not exist.

### Embodiment 6

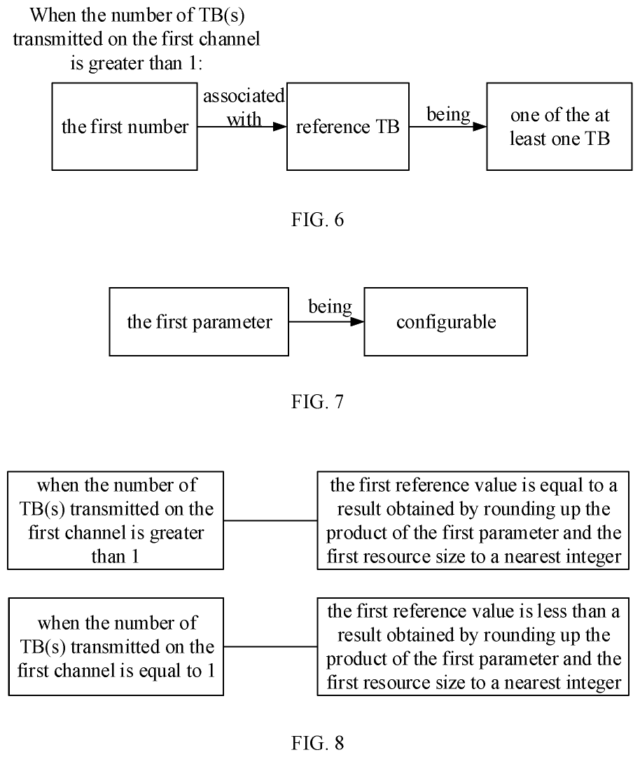

Embodiment 6 illustrates a schematic diagram of relations among a first number, a reference TB and at least one TB according to one embodiment of the present application, as shown in FIG. 6.

In Embodiment 6, when the number of TB(s) transmitted on the first channel is greater than 1, the first number is associated with a reference TB, the reference TB being one of the at least one TB.

In one embodiment, the reference TB is a transport block 1.

In one embodiment, the reference TB is a transport block 2.

In one embodiment, the reference TB is a transport block mapped to codeword 0.

In one embodiment, the reference TB is a transport block mapped to codeword 1.

In one embodiment, which TB of the at least one TB is the reference TB is pre-defined.

In one embodiment, which TB of the at least one TB is the reference TB is determined by a pre-defined rule.

In one embodiment, which TB of the at least one TB is the reference TB is configurable.

In one embodiment, when a number of TB(s) transmitted on the first channel is greater than 1, a parameter corresponding to the reference TB is used for indicating the first number.

In one embodiment, when a number of TB(s) transmitted on the first channel is greater than 1, determination of the first number depends on at least one of a size of a code block corresponding to the reference TB, a modulation order for the reference TB, or a number of transmission layer(s) corresponding to the reference TB.

In one embodiment, when a number of TB(s) transmitted on the first channel is greater than 1, one of the multiple values is

$$⌈ \frac{( O + L ) \cdot β \cdot {\sum }_{l = 0}^{N} M ( l )}{{\sum }_{r = 0}^{{C}_{TB} - 1} {K}_{r}} ⌉ ;$$

where O is equal to a number of bits in the first information block, L is equal to a number of CRC bit(s) for the first information block, β is an offset value for the first information block, M(l) is a number of RE(s) in OFDM symbol l that can be used for transmitting UCI, N is a total number of OFDM symbols of the first channel, a is configured by a higher layer parameter scaling, Kᵣ is a size of a r-th code block in the reference TB, and C_{TB} is a number of code blocks in the reference TB.

### Embodiment 7

Embodiment 7 illustrates a schematic diagram explaining a first parameter according to one embodiment of the present application, as shown in FIG. 7.

In Embodiment 7, the first parameter is configurable.

In one embodiment, the first parameter is configured by a higher layer signaling.

In one embodiment, the first parameter is configured by an RRC signaling.

In one embodiment, the first parameter is configured by a higher layer parameter scaling.

### Embodiment 8

Embodiment 8 illustrates a schematic diagram explaining a first reference value according to one embodiment of the present application, as shown in FIG. 8.

In Embodiment 8, a first reference value is one of the multiple values; when the number of TB(s) transmitted on the first channel is greater than 1, the first reference value is equal to a result obtained by rounding up a product of the first parameter and the first resource size to a nearest integer; when the number of TB(s) transmitted on the first channel is equal to 1, the first reference value is less than a result obtained by rounding up a product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, the statement that “the first reference value is less than a result obtained by rounding up a product of the first parameter and the first resource size to a nearest integer” comprises that: the first reference value is equal to the result obtained by rounding up the product of the first parameter and the first resource size to a nearest integer being subtracted by a second reference value, the second reference value being related to a HARQ-ACK.

In one embodiment, the meaning of the statement that “the first reference value is less than a result obtained by rounding up a product of the first parameter and the first resource size to a nearest integer” is that: the first reference value is equal to the result obtained by rounding up the product of the first parameter and the first resource size to a nearest integer being subtracted by a second reference value, the second reference value being related to a HARQ-ACK.

In one embodiment, the second reference value depends on a number of HARQ-ACK bit(s).

In one embodiment, the second reference value is a number of coding and modulation symbols per layer for HARQ-ACK transmission, or is a number of reserved resource elements for potential HARQ-ACK transmission in at least one OFDM symbol.

In one embodiment, when the number of HARQ-ACK bits is greater than 2, the second reference value is a number of coding and modulation symbols per layer for HARQ-ACK transmission; when the number of HARQ-ACK bit(s) is no greater than 2, the second reference value is a number of reserved resource elements for potential HARQ-ACK transmission in at least one OFDM symbol.

In one embodiment, the number of the TB(s) transmitted on the first channel is: a number of codeword(s) transmitted on the first channel.

In one embodiment, the number of the TB(s) transmitted on the first channel is equal to a number of codeword(s) transmitted on the first channel.

In one embodiment, the first reference value depends on a number of TB(s) transmitted on the first channel.

In one embodiment, the first signaling is a first DCI, and the first channel is a first PUSCH, and the first information block is a CSI part 1.

In one embodiment, HARQ-ACK information is multiplexed onto the first PUSCH.

In one embodiment, no HARQ-ACK information is multiplexed onto the first PUSCH.

In one embodiment, whether the first reference value is less than the result obtained by rounding up the product of the first parameter and the first resource size to a nearest integer depends on indication by the first DCI.

In one embodiment, whether the first reference value is less than the result obtained by rounding up the product of the first parameter and the first resource size to a nearest integer depends on a number of TB(s) indicated by the first DCI.

In one embodiment, whether the first reference value is less than the result obtained by rounding up the product of the first parameter and the first resource size to a nearest integer depends on a number of codeword(s) indicated by the first DCI.

In one embodiment, whether the first reference value is less than the result obtained by rounding up the product of the first parameter and the first resource size to a nearest integer depends on a number of TB(s) transmitted on the first PUSCH indicated by the first DCI.

In one embodiment, whether the first reference value is less than the result obtained by rounding up the product of the first parameter and the first resource size to a nearest integer depends on a number of codeword(s) transmitted on the first PUSCH indicated by the first DCI.

In one embodiment, when the first DCI indicates a transmission of 1 TB on the first PUSCH, the first reference value is less than the result obtained by rounding up the product of the first parameter and the first resource size to a nearest integer; when the first DCI indicates a transmission of 2 TBs on the first PUSCH, the first reference value is the result obtained by rounding up the product of the first parameter and the first resource size to a nearest integer.

In one embodiment, when the first DCI indicates a transmission of 1 TB on the first PUSCH, the first reference value is less than the result obtained by rounding up the product of the first parameter and the first resource size to a nearest integer; when the first DCI indicates a transmission of 2 TBs on the first PUSCH, the first reference value is equal to the result obtained by rounding up the product of the first parameter and the first resource size to a nearest integer.

In one embodiment, the first node receives a second parameter, the second parameter indicating a maximum number of TB(s) or codeword(s) on a PUSCH.

### Embodiment 9

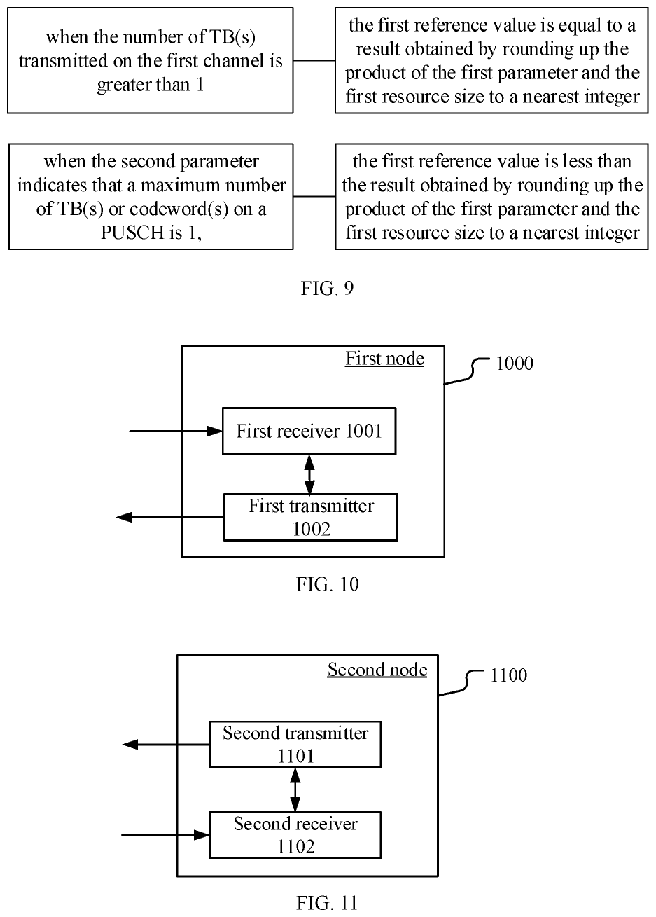

Embodiment 9 illustrates a schematic diagram explaining a first reference value according to one embodiment of the present application, as shown in FIG. 9.

In Embodiment 9, a first reference value is one of the multiple values, the second parameter indicating a maximum number of TB(s) or codeword(s) on a PUSCH; when the number of TB(s) transmitted on the first channel is greater than 1, the first reference value is equal to a result obtained by rounding up a product of the first parameter and the first resource size to a nearest integer; when the second parameter indicates that a maximum number of TB(s) or codeword(s) on a PUSCH is 1, the first reference value is less than the result obtained by rounding up the product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, the statements that “a maximum number of TB(s) or codeword(s) on a PUSCH” and “a maximum number of TB(s) or codeword(s) scheduled by a DCI” have equivalent meaning or are mutually replaceable.

In one embodiment, the statements that “a maximum number of TB(s) or codeword(s) on a PUSCH” and “a maximum number of TB(s) or codeword(s) that can be scheduled by single DCI” have equivalent meaning or are mutually replaceable.

The second parameter comprises one field in an IE.

In one embodiment, the second parameter is configured by a higher layer signaling.

In one embodiment, the second parameter is a higher layer parameter.

In one embodiment, the second parameter is an RRC layer parameter.

In one embodiment, a name of the second parameter includes maxNrofCodeWordsScheduledByDCI.

In one embodiment, a name of the second parameter includes maxNrofCodeWords.

In one embodiment, a name of the second parameter includes PUSCH.

In one embodiment, the second parameter is used for indicating a maximum number of TB(s) on a PUSCH.

In one embodiment, the second parameter is used for indicating a maximum number of codeword(s) on a PUSCH.

In one embodiment, when the second parameter indicates that a maximum number of TB(s) or codeword(s) on a PUSCH is 2 and that a number of TB(s) transmitted on the first channel is equal to 1, the first reference value is equal to the result obtained by rounding up the product of the first parameter and the first resource size to a nearest integer.

In one embodiment, when the second parameter indicates that a maximum number of TB(s) or codeword(s) on a PUSCH is 2 and that a number of TB(s) transmitted on the first channel is equal to 1, the first reference value is less than the result obtained by rounding up the product of the first parameter and the first resource size to a nearest integer.

In one embodiment, the second parameter is used for indicating a maximum number of TB(s) or codeword(s) scheduled by a DCI; when the number of TB(s) transmitted on the first channel is greater than 1, the first reference value is equal to a result obtained by rounding up a product of the first parameter and the first resource size to a nearest integer; when the second parameter indicates that a maximum number of TB(s) or codeword(s) scheduled by a DCI is 1, the first reference value is less than the result obtained by rounding up the product of the first parameter and the first resource size to a nearest integer; the first parameter is configurable, and the first resource size is a sum of multiple sub resource sizes, each of the multiple sub resource sizes being a number of RE(s) allowed to be used for transmitting UCI in an OFDM symbol.

In one embodiment, when the second parameter indicates that a maximum number of TB(s) or codeword(s) scheduled by a DCI is 2 and that a number of TB(s) transmitted on the first channel is equal to 1, the first reference value is equal to the result obtained by rounding up the product of the first parameter and the first resource size to a nearest integer.

In one embodiment, when the second parameter indicates that a maximum number of TB(s) or codeword(s) scheduled by a DCI is 2 and that a number of TB(s) transmitted on the first channel is equal to 1, the first reference value is less than the result obtained by rounding up the product of the first parameter and the first resource size to a nearest integer.

### Embodiment 10

Embodiment 10 illustrates a structure block diagram of a processing device in a first node, as shown in FIG. 10. In FIG. 10, a processing device 1000 in the first node is comprised of a first receiver 1001 and a first transmitter 1002.

In one embodiment, the first node 1000 is a base station.

In one embodiment, the first node 1000 is a UE.

In one embodiment, the first node 1000 is a relay node.

In one embodiment, the first node 1000 is vehicle-mounted communication equipment.

In one embodiment, the first node 1000 is a UE supporting V2X communications.

In one embodiment, the first node 1000 is a relay node supporting V2X communications.

In one embodiment, the first node 1000 is a UE supporting operations on high-frequency spectrum.

In one embodiment, the first node 1000 is a UE supporting operations on shared spectrum.

In one embodiment, the first node 1000 is a UE supporting XR services.

In one embodiment, the first node 1000 is a UE supporting multicast transmission.

In one embodiment, the first receiver 1001 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1001 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1002 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1002 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1002 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1002 comprises at least the first three of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1002 comprises at least the first two of the antenna 452, the transmitter 454, the multi-antenna transmitting processor 457, the transmitting processor 468, the controller/processor 459, the memory 460 and the data source 467 in FIG. 4 of the present application.

In one embodiment, the first receiver 1001 receives a first signaling; the first transmitter 1002 transmits a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of RE(s) allowed to be used for transmitting UCI in an OFDM symbol.

In one embodiment, when the number of TB(s) transmitted on the first channel is greater than 1, the first number is associated with a reference TB, the reference TB being one of the at least one TB.

In one embodiment, a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, the first signaling is a DCI, and the first channel is a PUSCH, and the first information block is a CSI part 1.

In one embodiment, the first signaling is a first DCI, and the first channel is a first PUSCH, and the first information block is a CSI part 1; a first reference value is one of the multiple values; whether the first reference value is less than a result obtained by rounding up the product of the first parameter and the first resource size to a nearest integer is related to a number of TB(s) transmitted on the first PUSCH, and the first resource size is a sum of multiple sub resource sizes, each of the multiple sub resource sizes being a number of RE(s) allowed to be used for transmitting UCI in an OFDM symbol.

In one embodiment, the first receiver 1001 receives a second parameter, the second parameter indicating a maximum number of TB(s) or codeword(s) on a Physical Uplink Shared CHannel (PUSCH); herein, whether the first reference value is less than the result obtained by rounding up the product of the first parameter and the first resource size to a nearest integer is related to the second parameter.

In one embodiment, when the second parameter indicates that a maximum number of TB(s) or codeword(s) on a PUSCH is 1, the first PUSCH is used for transmitting at most one TB, and the first reference value is less than the result obtained by rounding up the product of the first parameter and the first resource size to a nearest integer; when the number of TBs transmitted on the first PUSCH is equal to 2, the first reference value is the result obtained by rounding up the product of the first parameter and the first resource size to a nearest integer.

### Embodiment 11

Embodiment 11 illustrates a structure block diagram a processing device in a second node according to one embodiment of the present application, as shown in FIG. 11. In FIG. 11, a processing device 1100 in the second node is comprised of a second transmitter 1101 and a second receiver 1102.

In one embodiment, the second node 1100 is a UE.

In one embodiment, the second node 1100 is a base station.

In one embodiment, the second node 1100 is satellite equipment.

In one embodiment, the second node 1100 is a relay node.

In one embodiment, the second node 1100 is vehicle-mounted communication equipment.

In one embodiment, the second node 1100 is UE supporting V2X communications.

In one embodiment, the second node 1100 is a device supporting operations on high-frequency spectrum.

In one embodiment, the second node 1100 is a device supporting operations on shared spectrum.

In one embodiment, the second node 1100 is a device supporting XR services.

In one embodiment, the second node 1100 is one piece of test apparatus, test equipment or test instrument.

In one embodiment, the second transmitter 1101 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1101 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1102 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1102 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least the first two of the antenna 420, the receiver 418, the multi-antenna receiving processor 472, the receiving processor 470, the controller/processor 475 and the memory 476 in FIG. 4 of the present application.

In one embodiment, the second transmitter 1101 transmits a first signaling; the second receiver 1102 receives a first information block and at least one TB on a first channel; herein, the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of RE(s) allowed to be used for transmitting UCI in an OFDM symbol.

In one embodiment, when the number of TB(s) transmitted on the first channel is greater than 1, the first number is associated with a reference TB, the reference TB being one of the at least one TB.

In one embodiment, a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

In one embodiment, the first signaling is a DCI, and the first channel is a PUSCH, and the first information block is a CSI part 1.

In one embodiment, the first signaling is a first DCI, and the first channel is a first PUSCH, and the first information block is a CSI part 1; a first reference value is one of the multiple values; whether the first reference value is less than a result obtained by rounding up the product of the first parameter and the first resource size to a nearest integer is related to a number of TB(s) transmitted on the first PUSCH, and the first resource size is a sum of multiple sub resource sizes, each of the multiple sub resource sizes being a number of RE(s) allowed to be used for transmitting UCI in an OFDM symbol.

In one embodiment, the second transmitter 1101 transmits a second parameter, the second parameter indicating a maximum number of TB(s) or codeword(s) on a Physical Uplink Shared CHannel (PUSCH); herein, whether the first reference value is less than the result obtained by rounding up the product of the first parameter and the first resource size to a nearest integer is related to the second parameter.

In one embodiment, when the second parameter indicates that a maximum number of TB(s) or codeword(s) on a PUSCH is 1, the first PUSCH is used for transmitting at most one TB, and the first reference value is less than the result obtained by rounding up the product of the first parameter and the first resource size to a nearest integer; when the number of TBs transmitted on the first PUSCH is equal to 2, the first reference value is the result obtained by rounding up the product of the first parameter and the first resource size to a nearest integer.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first receiver, receiving a first signaling; and
a first transmitter, transmitting a first information block and at least one transport block (TB) on a first channel;
wherein the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of resource element(s) (RE(s)) allowed to be used for transmitting Uplink Control Information (UCI) in an Orthogonal Frequency Division Multiplexing (OFDM) symbol.

2. The first node according to claim 1, characterized in that when the number of TB(s) transmitted on the first channel is greater than 1, the first number is associated with a reference TB, the reference TB being one of the at least one TB, and which TB of the at least one TB is the reference TB is determined by a pre-defined rule.

3. The first node according to claim 1, characterized in that the first information block comprises UCI; a rate matching output sequence length of a code block r corresponding to the first information block=└E/C┘, with E equal to a product of multiple factors, the first number being one of the multiple factors; where r is a code block number, and C is a number of code block(s) corresponding to the first information block; when the number of TB(s) transmitted on the first channel is greater than 1: one of the multiple factors is a number of transmission layer(s) occupied by a reference TB, the reference TB being one of the at least one TB, and which TB of the at least one TB is the reference TB is determined by a pre-defined rule.

4. The first node according to claim 2, characterized in that a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

5. The first node according to claim 4, characterized in that a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

6. The first node according to claim 4, characterized in comprising:
the first receiver, receiving a second parameter, the second parameter indicating a maximum number of TB(s) or codeword(s) on a Physical Uplink Shared CHannel (PUSCH);
wherein whether the first reference value is less than the result obtained by rounding up the product of the first parameter and the first resource size to a nearest integer is related to the second parameter.

7. The first node according to claim 2, characterized in that the first signaling is Downlink Control Information (DCI), and the first channel is a PUSCH.

8. A second node for wireless communications, characterized in comprising:
a second transmitter, transmitting a first signaling; and
a second receiver, receiving a first information block and at least one TB on a first channel;
wherein the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of RE(s) allowed to be used for transmitting UCI in an OFDM symbol.

9. The second node according to claim 8, characterized in that when the number of TB(s) transmitted on the first channel is greater than 1, the first number is associated with a reference TB, the reference TB being one of the at least one TB, and which TB of the at least one TB is the reference TB is determined by a pre-defined rule.

10. The second node according to claim 8, characterized in that the first information block comprises UCI; a rate matching output sequence length of a code block r corresponding to the first information block=└E/C┘, with E equal to a product of multiple factors, the first number being one of the multiple factors; where r is a code block number, and C is a number of code block(s) corresponding to the first information block; when the number of TB(s) transmitted on the first channel is greater than 1: one of the multiple factors is a number of transmission layer(s) occupied by a reference TB, the reference TB being one of the at least one TB, and which TB of the at least one TB is the reference TB is determined by a pre-defined rule.

11. The second node according to claim 9, characterized in that a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

12. The second node according to claim 11, characterized in that a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

13. The second node according to claim 9, characterized in that the first signaling is DCI, and the first channel is a PUSCH.

14. A method in a first node for wireless communications, characterized in comprising:
receiving a first signaling; and
transmitting a first information block and at least one TB on a first channel;
wherein the first signaling is used for scheduling the first channel, and a first number is used for transmission of the first information block on the first channel, the first number being related to a number of TB(s) transmitted on the first channel, and, the first number being equal to a smallest one of multiple values; one of the multiple values depends on a result obtained by rounding up a product of a first parameter and a first resource size to a nearest integer, where the first parameter is configurable, and the first resource size is linear with at least one sub resource size, each of the at least one sub resource size being a number of RE(s) allowed to be used for transmitting UCI in an OFDM symbol.

15. The method in the first node according to claim 14, characterized in that when the number of TB(s) transmitted on the first channel is greater than 1, the first number is associated with a reference TB, the reference TB being one of the at least one TB, and which TB of the at least one TB is the reference TB is determined by a pre-defined rule.

16. The method in the first node according to claim 14, characterized in that the first information block comprises UCI; a rate matching output sequence length of a code block r corresponding to the first information block=└E/C┘, with E equal to a product of multiple factors, the first number being one of the multiple factors; where r is a code block number, and C is a number of code block(s) corresponding to the first information block; when the number of TB(s) transmitted on the first channel is greater than 1: one of the multiple factors is a number of transmission layer(s) occupied by a reference TB, the reference TB being one of the at least one TB, and which TB of the at least one TB is the reference TB is determined by a pre-defined rule.

17. The method in the first node according to claim 15, characterized in that a first reference value is one of the multiple values; when the number of TB(s) transmitted on the first channel is greater than 1, the first reference value is equal to a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

18. The method in the first node according to claim 17, characterized in that a first reference value is one of the multiple values; when the number of TB(s) transmitted on the first channel is equal to 1, the first reference value is less than a result obtained by rounding up the product of the first parameter and the first resource size to a nearest integer, the first parameter being configurable, and the first resource size is a sum of multiple sub resource sizes, each of the multiple sub resource sizes being a number of RE(s) allowed to be used for transmitting UCI in an OFDM symbol.

19. The method in the first node according to claim 17, characterized in comprising:
receiving a second parameter, the second parameter indicating a maximum number of TB(s) or codeword(s) on a PUSCH;
wherein whether the first reference value is less than the result obtained by rounding up the product of the first parameter and the first resource size to a nearest integer is related to the second parameter.

20. The method in the first node according to claim 15, characterized in that the first signaling is DCI, and the first channel is a PUSCH.
